(19) United States
(12) Patent Application Publication
(10) Pub. No.: US 2012/0114118 A1
(43) Pub. Date: May 10, 2012

(54) KEY ROTATION IN LIVE ADAPTIVE STREAMING

(75) Inventor: Sanjeev VERMA, San Jose, CA (US)

(73) Assignee: SAMSUNG ELECTRONICS CO., LTD., Suwon City (KR)

(21) Appl. No.: 13/283,949

(22) Filed: Oct. 28, 2011

Related U.S. Application Data
(60) Provisional application No. 61/410,669, filed on Nov. 5, 2010.
(60) Provisional application No. 61/442,626, filed on Feb. 14, 2011.

(51) Int. Cl. H04L 9/08

(52) U.S. Cl. 380/42

(57) ABSTRACT

Key rotation required for adaptive streaming of data is described. Metadata is added or provides extensions to two file formats, namely, ISO-based FF (also known as MP4 FF) and MPEG2-TS. A new Sample Group Type box in ISO-based FF is introduced to support key rotation required in adaptive streaming use cases, especially for live adaptive streaming. A mapping from MPEG2-TS FF to ISO-based FF is also enabled with the introduction of this new Sample Group Type by embedding metadata required for key rotation. Key rotation needed for live adaptive streaming in a broadcast environment is enabled.

### CROSS-REFERENCE TO RELATED APPLICATIONS

This application claims priority under 35 U.S.C. §119(e) to Provisional Patent Application No. 61/410,669, filed Nov. 5, 2010 (Attorney Docket No. SISAP118P) entitled “ENCRYPTION SIGNALING FOR ADAPTIVE STREAMING TO A MEDIA PLAYER,” and to Provisional Patent Application No. 61/442,626, filed Feb. 14, 2011 (Attorney Docket No. SISAP118P2) entitled “ENCRYPTION SIGNALING TO SUPPORT LIVE ADAPTIVE STREAMING”, which are incorporated by reference herein in their entireties.

### TECHNICAL FIELD

The present invention relates generally to computer software and digital rights management of licensed content. More specifically, it relates to content licensing schemes, networking, and portable computing devices.

### BACKGROUND OF THE INVENTION

Specific file formats, such as MPEG2-TS (transport stream), PIFF, DECE, and CENC file formats meet the encryption signaling requirements for certain uses, specifically, for the “download” use case, so only single key is needed. Here, a file, such as a video or music, is downloaded in its entirety first, and then played on the media device.

However, in the live adaptive streaming use case, many file formats do not provide efficient key rotation, which is often needed for extra protection in live/adaptive streaming of files, or they do not provide it at all. As is known in the art, in live/adaptive streaming, a file is steaming to a media device. The source of the file is often broadcasting the video or data to many entities, so additional protection is needed because many subscribers will be getting the file, as such, the file should not be compromised. For this reason, extra security may be needed in protecting the streaming video or data.

Some existing FFs do not have any mechanism to support key rotation required for live streaming in broadcast environments. Sample Groups in ISO-based FFs are used to apply a set of parameters or attributes to a group of samples. CENC FF (adopted by MPEG DASH) allows the application of common set of encryption parameters by new Sample Group Types for a group of samples defined by SampleToGroup box. However, current group type definitions are very restrictive and cannot be applied to support various conditional access system (CAS) mechanisms.

Key rotation allows for rekeying segments of the steam, for example, several times per minute for this extra protection. It would be desirable for widely used file formats to support key rotation efficiently. One widely used file format is the ISO-based File Format. This format does not have an efficient mechanism for key rotation and, therefore, is not used often for live/adaptive streaming of video or data.

### SUMMARY OF THE INVENTION

General aspects of the invention include, but are not limited to methods, systems, apparatus, and computer-readable media for enabling message transmission in multimedia device networks.

One aspect of the present invention is a method of enabling secure adaptive streaming of data in an ISO-based file format. A long-term key is received through an initialization segment, the long-term key encrypted using a public key of a service provider, wherein the long-term key is used to encrypt a short-term key. The media player receives a media stream, wherein samples are grouped based on crypto-periods, wherein the media stream is scrambled by short-term keys, wherein the short-term keys change frequently. An encrypted short-term key is received at the media player. The streaming data is rendered on the media player by using the short-term keys to decrypt the samples in the crypto-periods, thereby enabling re-keying of segments of a media stream.

In another aspect of the present invention, a method of creating a data stream in MPEG-TS is described. A segment encryption box is added to a sidx container box, the encryption box having an additional URL for encryption parameters, an additional encrypted key element to carry encrypted traffic keys, and an initialization vector for each sample for random access. Parameters in a track encryption box are overriden with the encryption parameters. The initialization vector is in the sidx box at the beginning of a segment, and encryption signaling at the segment level and random access to individual samples are enabled.

In another aspect of the present invention, a media player or computing device has a processor, a network interface, and a memory component. The memory component stores an algorithm identifier for identifying an encryption algorithm, an initialization vector size value, and a long-term key identifier for locating a long-term key used for encrypting a short-term key.

### BRIEF DESCRIPTION OF THE DRAWINGS

The invention and the advantages thereof may best be understood by reference to the following description taken in conjunction with the accompanying drawings in which:

FIG. 1 is a diagram showing crypto-periods and segment boundaries for four media samples at different qualities;

FIG. 2 is a block diagram of a Sample Encryption Box in accordance with one embodiment;

FIG. 3 provides an illustration of segment index box (“sidx”) in 3GP FF in accordance with another embodiment;

FIG. 4 is a flow diagram of a process of enabling secured live adaptive streaming of data in an ISO-based file format in accordance with one embodiment of the present invention; and

FIGS. 5A and 5B are diagrams of a computing device suitable for implementing embodiments of the present invention.

In the drawings, like reference numerals are sometimes used to designate like structural elements. It should also be appreciated that the depictions in the figures are diagrammatic and not to scale.

### DETAILED DESCRIPTION OF THE INVENTION

Methods and systems for supporting key rotation required for adaptive streaming of data are described in the various figures. Embodiments of the present invention are related to current developments in MPEG regarding ISO-based file format (FF). In one embodiment metadata is added or provides extensions to two FFs, namely, ISO-based FF (also known as MP4 FF) and MPEG2-TS.

The PIFF/DECE FF technology is related to various embodiments of the present invention. PIFF (Protected Interoperable File Format) adds three additional boxes to ISO Base FF for protection signaling through UUID extensions. There are two boxes for encryption signaling: “TrackEncryptionBox” and “SampleEncryptionBox” in PIFF/DECE FF to signal encryption parameters. The “TrackEncryptionBox” is put at a high-level as a part of the “moov” container box and carries encryption parameters for the entire audio or video track. A “Sample Encryption Box” at movie fragment (“moof”) carries encryption parameters that can override those carried in “TrackEncryptionBox” and carries initialization vector parameter for the samples in the “moof” container to allow for random access. However, in the case of live or adaptive streaming, key rotation may be needed, i.e. re-keying every few seconds for extra protection.

In one embodiment, the invention introduces a new Sample Group Type box in ISO-based FF to support key rotation required in adaptive streaming use cases, especially for live adaptive streaming. In another embodiment, the invention allows for a mapping from MPEG2-TS FF to ISO-based FF with the introduction of this new Sample Group Type by embedding metadata required for key rotation.

The present invention enables implementing key rotation needed for live adaptive streaming in a broadcast environment. As mentioned, existing FFs either do not support key rotation or support it in an inefficient and cumbersome manner.

The new Sample Group type enables key rotation. The definition or type can be used with all ISO-based common encryption file formats. In the described embodiment, the ISO-based FF is used to illustrate various embodiments of the invention.

The goal of encryption signaling in a data stream is to pass encryption parameters such as encryption algorithm identifier, master key (also referred to as long-term key) identifier, initialization vector (IV), and a decryption key, to a media player so that the player can render the streamed content. In certain types of adaptive streaming, streams are divided into movie fragments, each fragment having a number of samples.

Live streaming mechanisms use key rotation (that is, a decryption key for the content is changed several times per minute by the service provider) so that controlled access to broadcasted streamed content is provided to the subscribers in a secure and tamper-proof manner. One such broadcast system is Digital Video Broadcast (DVB).

DVB has defined conditional access system (CAS) standards that define methods by which a media content stream can be obfuscated and where access is provided only to authorized subscribers who have a valid decryption key. The encryption parameters are typically carried in CAS systems through Entitlement Control Messages (ECMs) in MPEG2-TS.

The present invention provides extensions to Common Encryption Signaling Format (CENC) (ISO-based FF) to support live adaptive streaming. In this use case, an adaptive streaming mechanism is used to broadcast live content to a potentially large number of subscribers.

As noted, in various embodiments, a new Sample Group Type box is defined by extending the sample group boxes for audio and video tracks by adding elements needed to carry encryption signaling parameters for live adaptive streaming. This supports various CAS systems.

Various embodiments of the invention address the issue of enabling encryption signaling for both ISO-based FF and MPEG2-TS FF by adding metadata at appropriate places to support live adaptive streaming use case. Default values for encryption parameters: algorithm ID, IV_size, and master key ID, are in the TrackEncryptionBox (part of the “moov” box).
1. AlgorithmID: an identifier of the signal encryption mechanism, e.g., AES-CBC, AES-CTR etc.
2. KeyID: Key Identifier for the master key (long-term) encryption key.
3. IV_size: Initialization Vector size.
4. sourceURL: An out-of-band mechanism to signal other encryption parameters (specific to other encryption mechanisms); this is used mainly as a placeholder.

Currently, under the DVB standard, CAS deploys methods by which a live broadcast media stream is obfuscated and access is provided only to subscribers. This is presently achieved through a two-step encryption mechanism. In step one, the media stream is scrambled by a short-term key (control word) that is changed several times per minute by the service provider. The short-term key is sent in encrypted form by the service provider in the ECM (Entitlement Control Message). At step two the short term key is protected using a high-level authorization key (long-term key) sent to the subscriber in an Entitlement Management Message (EMM).

Similar mechanisms can be used by service providers to provide live adaptive streaming to a set of users. In adaptive streaming, a media player may be provided with several representations or qualities (different network rates, quality, and the like) of the same media stream. The media player can adapt to existing network conditions (typically relating to bandwidth) by switching between these representations at segment boundaries. Each representation consists of several segments that can be individually accessed through URLs provided in a manifest file (e.g., an MPD file).

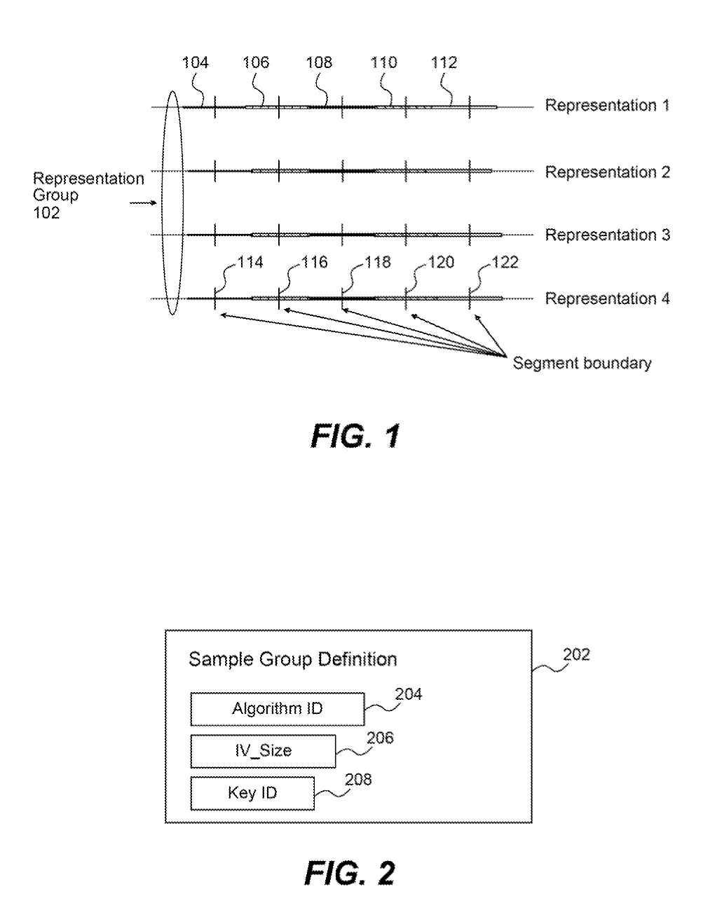

As noted, in the live adaptive streaming case, a service provider provides an extra layer of security (as defined by various CAS standards) by changing keys several times in a minute, that is, by key rotation. This means that certain security parameters are applied to media samples over a certain time period. These time periods, referred to as crypto-periods, may not be aligned with the segment boundaries. FIG. 1 is a diagram showing crypto-periods and segment boundaries for four media samples at different qualities. A representation group 102 is made up of four representations (1-4), representing different qualities of service, such as bandwidth. A series of crypto-periods 104, 106, 108 and so on, each have crypto-boundaries at the ends of each of the periods (the periods are shown as having different weighted or shaded lines). The short-term keys change at the crypto-boundaries. A crypto-boundary is defined by a short-term key and a set of encryption parameters. A segment, however, is shown by vertical lines 114, 116, 118, and so on. The segment boundaries may not match up with the crypto-boundaries, as shown in FIG. 1. The present invention provides a mechanism to apply certain encryption parameters and decryption keys to a group of samples belonging to a crypto-period. This can be achieved by defining a new Sample Group Type box to associate encryption parameters to a group of samples. In other embodiments, multiple boxes would be needed, one for each media stream. A similar box would be needed for an audio track.

In one embodiment, the first step in the scheme is for the subscriber to obtain a long-term key through a service-provider specific mechanism. For example, it may be signaled through the “pssh” box in the “moov” container box. For instance, it can be an OMA DRM key. This is a high-level or master key related to the subscription and can be delivered to each subscriber and is encrypted using the public key of the subscriber. This long-term or master key is used by the service provider to encrypt the short-term key.

In the second step, key rotation can be achieved by grouping samples belonging to a crypto-period. The samples are assigned a set of encryption parameters through a new SampleDescriptionBox containing the sample group. An opaque box may be defined allowing different service providers to provide system specific parameters. This opaque box may contain a decryption key for the crypto-period, where the decryption key is encrypted using the master key that a subscriber obtains in the first step through a “moov” box or inititialization segment.

In the “moov” box, there is a Key ID that identifies high-level or master key. A short-term key, K1, is encrypted using the master key, which is obtained from Key ID. The “moov” header contains the Key ID, which identifies the master key. A sample group type box (one for video and one for audio) contains the Key ID (pointer to a master key). The short-term key is the key that is encrypted using the long-term key. The media player first gets the master key in the Sample Group Type box. It does this using the KID. This is followed by the media player decrypting the short-term key in the same box using the master key.

Below is the Sample Group Type box definition that contains certain encryption signaling parameters associated with the crypto-period. FIG. 2 is a block diagram of a Sample Encryption Box 202. It contains a sample group definition that includes an algorithm ID 204, an IV_size 206, and a KID 208. New box 202, which may be referred to in one embodiment as “CencKeyRotSampleEncryptionInformationVideoGroupEntry”, enables key rotation in ISO-based file formats. The code below illustrates one embodiment for video track.

```
aligned(8) class
CencKeyRotSampleEncryptionInformationVideoGroupEntry
  extends VideoSampleGroupDescriptionEntry(‘serg’)
{
      unsigned int(24)  AlgorithmID;
      unsigned int(8) IV_size;
```

| | |
|---|---|
| unsigned int(8)[16] KID; | //Identifies the Long-term or |

```
                  //Master key delivered using protection system
                  //specific key management protocol.
      unsigned int(32) KeySize;
      unsigned int (8)[KeySize] encryptedKey;
            //short-term key encrypted using Long-term or Master Key.
}
```

The code below illustrates another embodiment for an audio track.

```
aligned(8) class
CencKeyRotSampleEncryptionInformationAudioGroupEntry
  extends AudioSampleGroupDescriptionEntry(‘serg’)
{
    unsigned int(24) AlgorithmID;
    unsigned int(8) IV_size;
    unsigned int(8)[16] KID; //Identifies the Long-term or Master key
```

//delivered using protection system specific
//key management protocol.

```
    unsigned int(32) KeySize;
    unsigned int (8)[KeySize] encryptedKey;
      //short-term key encrypted using Long-term or Master Key
}
```

In another embodiment, key rotation is enabled for MPEG2-TS file format. Here key rotation is done using the “sidx” box for adaptive streaming because all the packets need to be scanned to see where encryption signaling starts. Thus, from the sidx box, it is possible to do encryption signaling for segments. This additional box, in front of the media segment (referred from segment index box), is used for encryption signaling and randomly accessing a sample within the segment. MPEG2-TS signals encryption parameters through ECMs embedded in the transport stream. Currently MPEG2-TS uses ECMs (Entitlement Control Messages) for encryption signaling. However, random access to a sample in the stored file is not possible in case of current MPEG2-TS packet stream. The media player needs to go sequentially through stored TS packets to find the encryption parameters associated with a random sample.

In one embodiment, placement of the encryption box in the 3GP FF is important. Adaptive streaming has a notion of segments, i.e. audio/video streams are segmented into fixed sized chunks (each typically a few seconds long). As noted, MPEG2-TS 3GP has added an additional “sidx” box for segmentation. In one embodiment, the invention involves adding an encryption signaling element into the 3GP FF. This box enables both encryption signaling at the segment level, in addition to random access to individual samples in the segment. Random access is an important concept in adaptive streaming because it facilitates trick play. It should be possible to access any sample within the media segment.

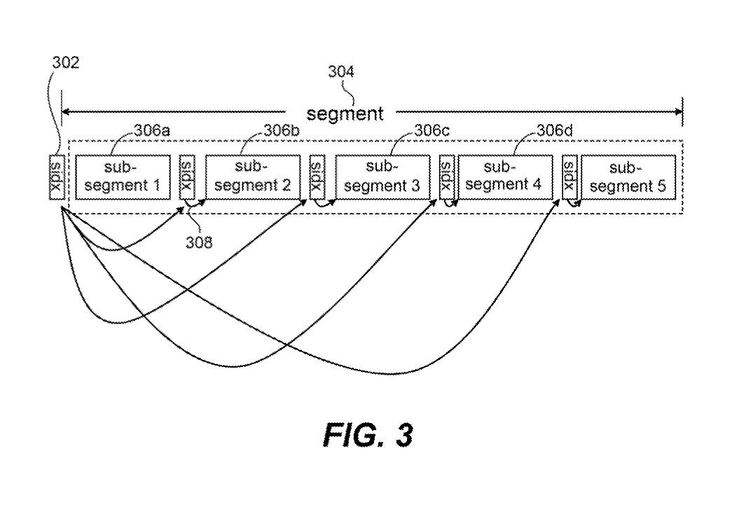

FIG. 3 provides an illustration of segment index box (“sidx”) in 3GP FF. The main purpose of this box is to provide signaling at segment level for random access (offset etc.) and relative timing information (note that there is no concept of absolute timing in ISO-based FF in comparison to MPEG2-TS). This box appears at basically two levels: segment level where reference is to segment index boxes at sub-segment levels, and at the sub-segment level, where the reference is to a movie fragment box (“moof” box).

In one embodiment, the encryption signaling box is added at the segment level box (“sidx”) in the 3GP FF. In one embodiment, the invention targets the live/adaptive streaming case, where frequent re-keying might be needed for additional protection.

In one embodiment, the invention adds an additional “SegmentEncryptionBox” (“sidx” box) to the 3GP FF to carry encryption parameters at the segment level. These parameters are: AlgoirthmID (AES-CBC, AES-CTR etc.), KeyID (encryption key identifier; key delivered through a separate protocol/mechanism), and IV_Size. In one embodiment, an additional URL may be included so that additional security parameters can be retrieved by the media player.

As noted, in one embodiment, an additional box, the “sidx” box, is added to 3GP FF, before a media segment. A segment is an adaptive streaming concept where a media stream is divided into fixed size segments to adapt to, by switching to a different rate, changing network environments, etc. This additional sidx box contains the encryptions parameters that may change every few seconds. It also allows random access to a Sample within the segment.

The AES-CBC encryption mechanism is a commonly used mechanism in the industry to encrypt media content. A first sample (block) needs an encryption parameter IV in a CBC block chain. The remaining samples use the ciphertext out of the preceding samples as the IV. Therefore, in order to randomly access a sample, the media player has to do all the ciphertext calculation in the daisy chain. This can be very time consuming for a media player. Thus, it would be preferable and more efficient to have the IV for all the samples signaled to the media player through an element or box in the FF, such as in the “sidx” box.

In one embodiment, the invention signals all initialization vectors (IVs) through the first “sidx” box that refers to all sub-segment level “sidx” boxes. This enables a media player to randomly access any intermediate Sample. The syntax of the “SegmentEncryptionBox” is shown below. Note that “reference_type” indicates whether the reference is being made to another “sidx” box (reference_type=1) or to a movie fragment box (“moof”) (reference_type=0). In this embodiment, all the IVs are put in the first “sidx” box that refers to all samples within a segment.

### SegmentEncryptionBox

```
Aligned(8) class SegmentEncryptionBox extends FullBox(“uuid”,
extended_type=0x...version0..
{
      if(flags&override)
      {
      unsigned int(24)  AlgorithmID;
      unsigned int(8) IV_size;
      unsigned int(8)[16] KID;
      string  sourceURL:/*retrieve additional security parameters*/
if (reference_type==1){
      unsigned int(32)  reference_count
      {
      unsigned int (IV_size)  Initialization vector
}
```

Below is the syntax of a Segment Index Box (“sidx” box).

### Segment Index Box Syntax

```
aligned(8) class SegmentIndexBox extends FullBox(‘sidx’, version, 0) {
                  unsigned int(32) reference_track_ID;
                    unsigned int(16) track_count;
                  unsigned int(16) reference_count;
                    for (i=1; i<= track_count; i++)
                                  {
                        unsigned int(32)  track_ID;
                                if (version==0)
                                      {
                          unsigned int(32)  decoding_time;
                                    } else
                                      {
                          unsigned int(64)  decoding_time;
                                      }
                                  }
                  for(i=1; i <= reference_count; i++)
                                  {
                bit (1)  reference_type;
                    unsigned int(31)  reference_offset;
                  unsigned int(32)  subsegment_duration;
                bit(1)  contains_RAP;
                    unsigned int(31)  RAP_delta_time;
                                  }
                            }
```

FIG. 3 is a diagram showing a first sidx box and a segment. A first sidx box 302 references a segment 304. Segment 304 is divided into sub-segments 306a, 306b, 306c . . . . The first sidx box 302 references the segment index boxes (“sidx” boxes) of the sub-segments 306a,b . . . contained within segment container 304. The inner sidx boxes, such as box 308, references the first movie fragment of the sub-segment. Each sub-segment consists of one or more movie fragments. Each movie fragment consists of one or more samples.

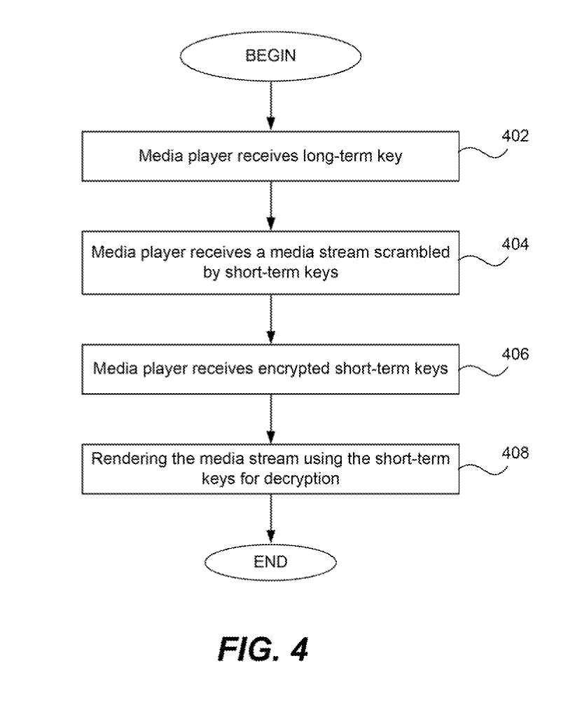

FIG. 4 is a flow diagram of a process of enabling secured live adaptive streaming of data in an ISO-based file format in accordance with one embodiment of the present invention. At step 402 an initialization segment of the media stream provides the media player with a long-term key. In one embodiment, the long-term key is used to encrypt a short-term (control word) key that is used to define crypto-boundaries. At step 404 the media player receives the media stream having samples grouped based on crypto-periods, as described above. In one embodiment, the media stream is scrambled by multiple short-term keys, which change frequently, e.g., every 5-10 seconds. The short-term keys are decrypted using the long-term key. At step 406 the media player receives encrypted short-term keys in an entitlement control message (ECM). At step 408 the media stream is played or rendered on the media player by using the multiple short-term keys to decrypt the samples in the crypto-periods. This process as a whole enables re-keying of segments in the media stream.

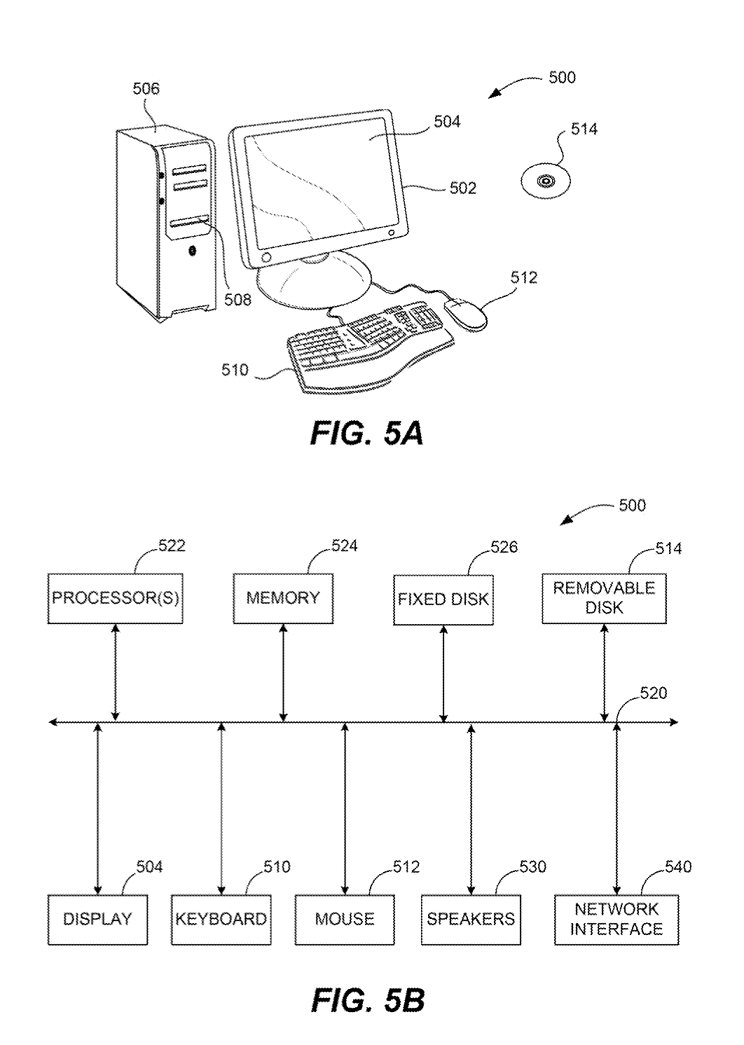

As noted above, there are various types of computing or software execution devices and systems utilized in the in the present invention, including but not limited to license servers, TVs, and mobile devices (such as cell phones, tablets, media players, and the like). FIGS. 5A and 5B illustrate a computing or software execution device 500 suitable for implementing specific embodiments of the present invention. FIG. 5A shows one possible physical implementation of a computing system. In one embodiment, system 500 includes a display 504. It may also have a keyboard 510 that is shown on display 504 or may be a physical component that is part of the device housing. It may have various ports such as HDMI, DVI, or USB ports (not shown). Computer-readable media that may be coupled to device 500 may include USB memory devices and various types of memory chips, sticks, and cards.

FIG. 5B is an example of a block diagram for computing system 500. Attached to system bus 520 is a variety of subsystems. Processor(s) 522 are coupled to storage devices including memory 524. Memory 524 may include random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 526 is also coupled bi-directionally to processor 522; it provides additional data storage capacity and may also include any of the computer-readable media described below. Fixed disk 526 may be used to store programs, data and the like and is typically a secondary storage medium that is slower than primary storage. It will be appreciated that the information retained within fixed disk 526, may, in appropriate cases, be incorporated in standard fashion as virtual memory in memory 524.

Processor 522 is also coupled to a variety of input/output devices such as display 504 and network interface 540. In general, an input/output device may be any of: video displays, keyboards, microphones, touch-sensitive displays, tablets, styluses, voice or handwriting recognizers, biometrics readers, or other devices. Processor 522 optionally may be coupled to another computer or telecommunications network using network interface 540. With such a network interface, it is contemplated that the CPU might receive information from the network, or might output information to the network in the course of performing the above-described method steps. Furthermore, method embodiments of the present invention may execute solely upon processor 522 or may execute over a network such as the Internet in conjunction with a remote processor that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are illustrative and not restrictive, and the invention is not to be limited to the details given herein, but may be modified within the scope and equivalents of the appended claims.

What is claimed is:

1. A method of enabling secure adaptive streaming of data in an ISO-based file format, the method comprising:
receiving a long-term key through an initialization segment, the long-term key encrypted using a public key of a service provider, wherein the long-term key is used to encrypt a short-term key;
receiving a media stream, wherein samples are grouped based on a plurality of crypto-periods, wherein the media stream is scrambled by a plurality of short-term keys, wherein the short-term keys changes frequently,
receiving an encrypted short-term key; and
rendering the streaming data by using the plurality of short-term keys to decrypt the samples in the plurality of crypto-periods, thereby enabling re-keying of segments of a media stream.

2. A method as recited in claim 1 further comprising:
storing the short-term key, an encryption algorithm identifier, and initialization vector length in a sample group type box.

3. A method as recited in claim 1 wherein key rotation for the ISO-based file format media stream is supported.

4. A method as recited in claim 1 further comprising receiving a decryption key.

5. A method as recited in claim 2 wherein the sample group type box supports conditional access systems.

6. A method as recited in claim 1 further comprising:
storing default values in a TrackEncryptionBox.

7. A method as recited in claim 1 further comprising:
signaling the long-term key through a ‘pssh’ box in a ‘moov’ container box.

8. A method as recited in claim 1 further comprising:
grouping samples belonging to a crypto-period to achieve key rotation.

9. A method of creating a data stream in MPEG-TS, the method comprising:
adding a segment encryption box in a sidx container box, said encryption box having an additional URL for encryption parameters, an additional encrypted key element to carry encrypted traffic keys, and an initialization vector for each sample for random access; and
overriding parameters in a track encryption box with said encryption parameters,
wherein the initialization vector is in the sidx box at the beginning of a segment, and wherein encryption signaling at the segment level and random access to individual samples are enabled.

10. A method as recited in claim 9 wherein the sidx container box appears at a segment level where reference is to segment index boxes at sub-segment levels and to a movie fragment box at a sub-segment level.

11. A method as recited in claim 9 wherein extensions to common encryption signaling format (CENC) are provided.

12. A method as recited in claim 9 further comprising providing a sample encryption box.

13. A method as recited in claim 9 further comprising:
providing signaling at a segment level for random access and relative timing information.

14. A media player comprising:
a processor;
a network interface; and
a memory component storing an algorithm identifier for identifying an encryption algorithm, an initialization vector size value, and a long-term key identifier for locating a long-term key used for encrypting a short-term key.

15. A media player as recited in claim 14 wherein the memory component further stores a sample group type box for storing said encryption algorithm, initialization vector size value, and long-term key identifier.

16. A media player as recited in claim 14 wherein samples of a media stream are grouped based on crypto-period to achieve key rotation.
